(19) United States
(12) Patent Application Publication
(10) Pub. No.: US 2024/0246247 A1
(43) Pub. Date: Jul. 25, 2024

(54) JOINT STRUCTURE OF ROBOT

(71) Applicant: TOYOTA JIDOSHA KABUSHIKI KAISHA, Toyota-shi (JP)

(72) Inventor: Hiroyuki KONDO, Chofu-shi (JP)

(73) Assignee: TOYOTA JIDOSHA KABUSHIKI KAISHA, Toyota-shi (JP)

(21) Appl. No.: 18/541,850

(22) Filed: Dec. 15, 2023

(30) Foreign Application Priority Data
Jan. 19, 2023 (JP) 2023-006311

(51) Int. Cl. B25J 17/00

(52) U.S. Cl. CPC B25J 17/00

(57) ABSTRACT

A joint structure of a robot according to the present disclosure includes: a first link whose one end of the first link is connected to a first member; a second link; a first pivot connected to an other end of the first link and connected to one end of the second link; and a second pivot connected to an other end of the second link and connected to one end of a second member. The joint structure includes: an actuator that rotates the first pivot; a third link whose one end of the third link is connected to the second pivot and which faces in a direction away from the second link; and a force application part. The force application part applies a force on a line connecting a predetermined position on the first link to an other end of the third link.

### CROSS REFERENCE TO RELATED APPLICATIONS

This application is based upon and claims the benefit of priority from Japanese patent application No. 2023-6311, filed on Jan. 19, 2023, the disclosure of which is incorporated herein in its entirety by reference.

### BACKGROUND

The present disclosure relates to a joint structure of a robot.

Japanese Unexamined Patent Application Publication No. 2006-43871 discloses a walking apparatus including a foot part, a waist part, and a leg part provided between the foot part and the waist part and used for a biped walking robot.

### SUMMARY

However, the walking apparatus disclosed in Japanese Unexamined Patent Application Publication No. 2006-43871 cannot operate the ankle joint independently, although it has a structure in which actuators having three degrees of freedom are integrated in the waist part.

The present disclosure has been made in order to solve the above-described problem and an object thereof is to provide a joint structure of a robot by which a second joint can be operated independently of a first joint while an actuator that drives the first joint secures its driving force.

A joint structure of a robot according to the present disclosure includes: a first link, one end of the first link being connected to a first member; a second link; a first pivot connected to an other end of the first link and connected to one end of the second link; a second pivot connected to an other end of the second link and connected to one end of a second member; an actuator configured to rotate the first pivot; a third link, one end of the third link being connected to the second pivot and the third link facing in a direction away from the second link; and a force application part configured to apply a force on a line connecting a predetermined position on the first link to an other end of the third link.

According to the present disclosure, it is possible to provide a joint structure of a robot by which a second joint can be operated independently of a first joint while an actuator that drives the first joint secures its driving force.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1A is a schematic diagram showing a first configuration example of a joint structure of a biped walking robot according to an embodiment;

FIG. 1B is a schematic diagram showing a second configuration example of a joint structure of a biped walking robot according to the embodiment;

FIG. 1C is a schematic diagram showing a comparative example of the joint structure of the biped walking robot;

FIG. 2 is a schematic diagram showing a change in a posture during jumping action in the second configuration example of FIG. 1B;

FIG. 3A shows graphs showing results of calculating the displacements of respective joint parameters in accordance with the change in the posture shown in FIG. 2;

FIG. 3B shows graphs showing results of calculating the displacement in the same manner as in FIG. 3A for the comparative example shown in FIG. 1C;

FIG. 4A is a schematic diagram showing a third configuration example of a joint structure of a biped walking robot according to the embodiment;

FIG. 4B is a schematic diagram showing a fourth configuration example of a joint structure of a biped walking robot according to the embodiment;

FIG. 4C is a schematic diagram showing a fifth configuration example of a joint structure of a biped walking robot according to the embodiment;

FIG. 5A is a schematic diagram showing a sixth configuration example of a joint structure of a biped walking robot according to the embodiment;

FIG. 5B is a schematic diagram showing a seventh configuration example of a joint structure of a biped walking robot according to the embodiment;

FIG. 5C is a schematic diagram showing an eighth configuration example of a joint structure of a biped walking robot according to the embodiment; and

FIG. 6 shows graphs showing results of calculating the displacements of the respective joint parameters in accordance with a change in a posture during jumping action in the sixth configuration example shown in FIG. 5A.

### DESCRIPTION OF EMBODIMENTS

The present disclosure will be described hereinafter through an embodiment of the present disclosure. However, the following embodiment is not intended to limit the scope of the present disclosure according to the claims. Further, all the components/structures described in the embodiment are not necessarily essential as means for solving the problem.

### Embodiment

The following description will be given in accordance with the assumption that a joint structure of a robot according to this embodiment is applied as joints to the knee and the ankle of a target robot, that is, a mobile robot as a target mobile body, is a biped walking robot capable of walking on two legs. However, the present disclosure is not limited thereto.

### FIRST CONFIGURATION EXAMPLE

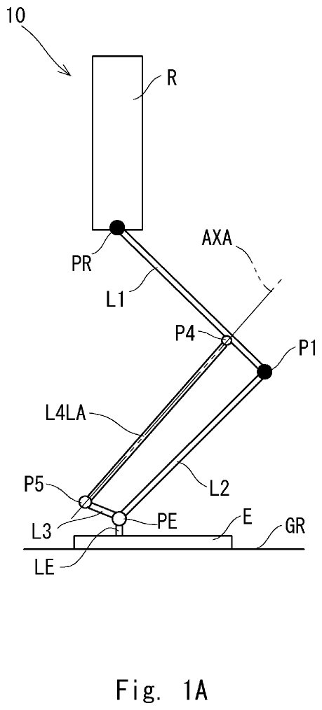

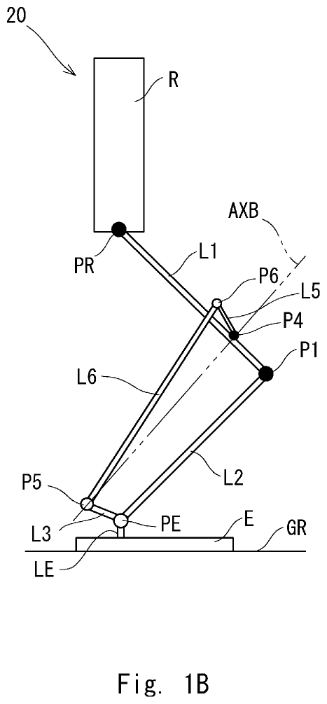

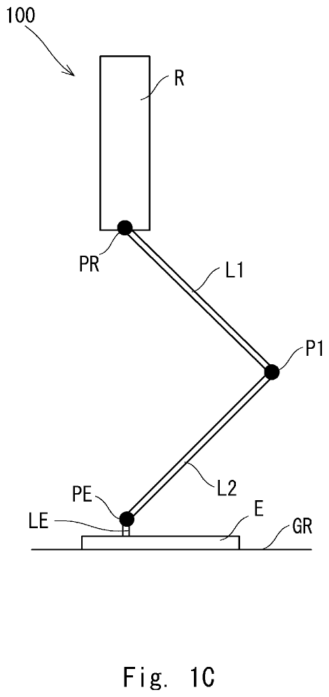

As shown in FIG. 1A, a joint structure 10 of a biped walking robot according to a first configuration example includes a link L1, a link L2, a pivot P1, and a pivot PE. Further, the joint structure 10 may include a pivot PR, a link LE, and members R and E.

The link L1 is an example of a first link whose one end is connected to the pivot PR which is an example of a first member. In addition to the link L1, the member R can be connected to the pivot PR so as to be rotatable with respect to the link L1. The description will be given in accordance with the assumption that the first member is the pivot PR. However, the first member may be a member which does not have a pivot function, or may be, for example, the member R that does not include the pivot PR and is directly connected to the link L1. Note that pivots such as the pivots PR, P1, and PE, and pivots P4, P5, etc. which will be described later, serve as members for rotatably connecting members to each other such as links connected thereto. The link L2 is an example of a second link.

The pivot P1 is an example of a first pivot connected to the other end of the first link exemplified by the link L1 and connected to one end of the second link exemplified by the link L2. Further, in order to move the pivot P1, which is one of the joints, the joint structure 10 includes an actuator (not shown) that rotates the pivot P1. The actuator that rotates the pivot P1 may be a rotary actuator composed of a motor in which a rotation axis is arranged at the center of the pivot P1. Each pivot indicated by a black circle in FIG. 1A and FIGS. 1B, 1C, 2, 4A, 4B, 4C, 5A, 5B, and 5C described later, including the pivot P1, may be provided with a similar rotary actuator for rotating the pivot. As a matter of course, each pivot may be regarded as a rotary actuator itself provided at that position. Further, the actuator in each pivot is not limited to a rotary actuator, and any mechanism that can be rotated in each pivot, such as a linear actuator configured to drive each drive joint, may be used.

The pivot PE is an example of a second pivot connected to the other end of the second link exemplified by the link L2 and connected to one end of the link LE which is an example of a second member. As described above, the link L2 is a link in which one end thereof is connected to the pivot P1 and the other end thereof is connected to the pivot PE. Further, one end of the link LE is connected to the pivot PE so as to be rotatable with respect to the link L2. Further, the member E can be connected to the other end of the link LE. However, the joint structure 10 may have a structure in which the pivot PE is directly provided in the member E without including the link LE.

Further, the joint structure 10 includes an actuator that rotates the first pivot as exemplified by the pivot P1, a third link whose one end is connected to the second pivot as exemplified by the pivot PE and which faces in a direction away from the second link as exemplified by the link L2, and a force application part.

As an example of the third link, the joint structure 10 includes a link L3 whose one end is connected to the pivot PE and which faces in a direction away from the link L2. Note that the link L3 and the link LE are connected to the pivot PE at a fixed angle. That is, the link L3 and the link LE are formed as one bent link. However, as described above, the joint structure 10 may have a structure in which the pivot PE is directly provided in the member E without including the link LE.

The force application part is a part that applies a force on a line connecting a predetermined position on the first link exemplified by the link L1 to the other end of the third link exemplified by the link L3. In the joint structure 10 according to the first configuration example, as an example of the force application part, pivot P4 and P5 and a link L4LA are provided, and a line AXA is shown as the aforementioned line.

The pivot P4 is an example of the fourth pivot connected to the aforementioned predetermined position on the link L1. The pivot P4 is a pivot connected to the predetermined position on the link L1 and connected to one end of the link L4LA, and can rotate the link L4LA with respect to the link L1 at the predetermined position. The rotation of the pivot P4 can be performed in response to a change of the length of the link L4LA as described later and rotation by a rotary actuator in the pivot P1. Further, the position of the pivot P4, that is, the aforementioned predetermined position, is set at a position on the link L1 near the pivot P1, whereby the movable range of the pivot P1 can be increased.

The pivot P5 is an example of the fifth pivot connected to the other end of the third link exemplified by the link L3. The pivot P5 is a pivot connected to the other end of the link L3 and connected to the other end of the link L4LA, and can rotate the link L4LA with respect to the link L3. The rotation of the pivot P5 can be performed in response to a change of the length of the link L4LA as described later and rotation by a rotary actuator in the pivot P1.

The link L4LA is an example of a configuration including a fourth link connecting the fourth pivot exemplified by the pivot P4 to the fifth pivot exemplified by the pivot P5, and an actuator that changes a length of the fourth link. The link L4LA is a variable-length link in which a linear actuator is provided. The linear actuator may be an actuator capable of changing a length of the link L4LA, that is, outputting linear motion, and may be, for example, a linear actuator incorporated in the link L4LA. However, instead of the linear actuator, the link L4LA may be provided with a rotary actuator and a conversion mechanism that performs conversion from rotational motion to linear motion.

Thus, the joint structure 10 includes a linear actuator that varies a distance between the pivot P4 and the pivot P5 or generates a force, and a rotary actuator that drives the pivot P1 in a closed loop composed of a part of the link L1 and the links L2, L3, and L4LA.

In the joint structure 10, since one closed loop is driven by two actuators, the pivot P1 and the pivot PE are affected by each other's posture and torque, that is, the pivot P1 and the pivot PE are interference-driven. In the joint structure 10, although the output of the pivot PE is less than that in a non-interference-driven configuration, the torque of the pivot P1 is increased. Therefore, it is preferable to move an actuator different from that provided in the pivot P1 by a link mechanism or the like to the member R or a position close to it. Note that the fact that the output of the pivot PE is reduced means that the mass of the pivot PE side can be made lighter than that of the pivot PR side. A configuration example in which an actuator is moved to the member R side will be described later as a third configuration example and a fourth configuration example.

The biped walking robot may be a robot including the joint structure 10 described above as a leg structure for each of the left and right legs. At this time, the member R corresponds to a body part commonly connected to the right and left legs, specifically, a body part commonly connected to the right and left pivot PRs. Further, the pivot PR corresponds to the hip joint, the pivot P1 corresponds to the knee joint, the member E corresponds to the foot, and the pivot PE corresponds to the top of the foot, for example, the ankle joint also referred to as the ankle joint. In other words, the pivot PR may be provided with an actuator for driving the hip joint, and the pivot P1 and the link L4LA may be provided with actuators for driving the knee joint and the ankle joint. The member E as the foot is grounded to a ground GR at least in the stance. As a matter of course, the biped walking robot is not limited to the above-described leg-type robot, and it may also include other parts such as the arm(s) and the head.

As described above, in the joint structure 10, the pivot P1 can be applied so as to serve as a knee joint, which is a joint in which a load is increased, and the pivot PE can be applied so as to serve as an ankle joint, which has a smaller load than that in the knee joint. Further, in the joint structure 10, the link L1 links the torso position with the knee position where an actuator is provided, the link L2 links the knee position with the ankle position, and the link L3 is connected to the ankle position and faces in a direction away from the link L2, so that a force can be applied on the line AXA.

In the joint structure 10, with such a configuration, the force generated from both the force application part and the actuator of the pivot P1 can be utilized for the movement of the ankle, and the movement of the ankle joint in which a driving force is secured by the actuator of the pivot P1 can be performed.

Further, as can be seen from a second configuration example to an eighth configuration example described later, a similar effect can be obtained not only in the first configuration example but also in the following joint structure. That is, this joint structure includes a first link whose one end is connected to the first member, a second link, a first pivot connected to the other end of the first link and connected to one end of the second link, and a second pivot connected to the other end of the second link L2 and connected to one end of the second member. This joint structure also includes an actuator that rotates the first pivot, a third link whose one end is connected to the second pivot and which faces in a direction away from the second link, and a force application part. Note that the force application part applies a force on a line connecting a predetermined position on the first link to the other end of the third link. According to the above joint structure, a second joint exemplified by an ankle joint can be operated independently of a first joint exemplified by a knee joint while an actuator that drives the first joint secures its driving force. On the other hand, for example, although the ankle can be operated by connecting the foot (sole) and the shin by a linear actuator, the ankle cannot obtain a driving force only from the linear actuator. Thus, there is a possibility of an insufficient driving force. However, by the above-described joint structure according to this configuration example and the like, the aforementioned insufficient driving force can be prevented.

Further, as shown in FIG. 1A showing the ground GR and illustrating the member R as a body part and the member E as a foot, the pivot PR may be a member closer to the center of gravity of the biped walking robot than the pivot PE is. In particular, the above configuration is employed in the leg structure since it is desirable that the total mass be light and the mass distribution be light as it goes from the crotch part to the foot part of the leg. However, although the mass shifts away from the center of gravity compared to the joint structure 10, a configuration obtained by vertically inverting a configuration between the pivot PE and the pivot PR shown in FIG. 1A may be employed.

Further, the joint structure 10 may include a changing mechanism that changes the aforementioned predetermined position. The same applies to the second to the eighth configuration examples described later. In fact, by changing the aforementioned predetermined position, the appearance of the robot and the range of motion, torque, angular velocity of rotation, etc. required for each joint are changed, and it can be said that they are in the relationship of trade-off. For example, the longer the link L3 is, the stronger the moment (torque). However, the appearance becomes bad, the angular velocity is reduced, and in particular, the range of motion of the knee joint is reduced. Further, the closer the pivot P4 is to the pivot PR, the stronger the torque. However, similarly, the appearance becomes bad, the angular velocity is reduced, and in particular, the range of motion of the knee joint is reduced.

The above-described changing mechanism may be, for example, a mechanism that mechanically changes a position of the pivot P4 on the link L1, a mechanism that mechanically changes a length of the link L3, or a mechanism that performs both. The robot may for example, determine an optimal position as the aforementioned predetermined position by using a least squares method or the like in accordance with the operation mode of the robot and taking into consideration the aforementioned relationship of trade-off, and operate the above-described changing mechanism so as to be at the determined optimal position. Alternatively, the above-described changing mechanism may be a mechanism that manually changes the determined position as described above. In either configuration, the robot can change the joint structure to a structure suitable for its operation mode, and perform an operation suitable for the operation mode. Further, in the robot, the operation mode can be changed in accordance with, for example, the purpose of operating the robot, the environment of the robot's motion, that is, the state of the motion, etc. As a matter of course, a joint structure in which the aforementioned predetermined position is fixed by taking into consideration the trade-off described above without the above-described changing mechanism being provided may be incorporated into the robot.

### SECOND CONFIGURATION EXAMPLE

A joint structure 20 according to a second configuration example and a joint structure 100 according to a comparative example will be described with reference to FIGS. 1B, 1C, 2, 3A, and 3B with a fucus on differences between these structures and that according to the first configuration example. In the second configuration example, various examples described in the first configuration example can be similarly applied.

As shown in FIG. 1B, the joint structure 20 has a structure similar to that of the joint structure 10 except for the structure of the force application part. The joint structure 10 includes the pivots P4 and P5 and the link L4LA as the force application part, and applies a force on the line AXA. Meanwhile, the joint structure 20 includes pivots P4, P5, and P6, and links L5 and L6 as the force application part, and the pivot P4 is provided with a rotary actuator, and applies a force on a line AXB. Note that the line AXB of the joint structure 20 may be the same line as or a different line from the line AXA of the joint structure 10, and it can be said that the same applies to a comparison with other configuration examples.

That is, the pivot P4 of the joint structure 20 is an example of the fourth pivot, which is a pivot provided at a predetermined position on the link L1 and enables the link L5 to rotate relative to the link L1, and is provided with a rotary actuator. The pivot P5 is an example of the fifth pivot connected to the other end of the third link exemplified by the link L3. A pivot P6 is an example of the sixth pivot. The links L5 and L6, unlike the link L4LA, are normal links without including actuators. The link L5 is an example of the fifth link connecting the fourth pivot exemplified by the pivot P4 to the sixth pivot exemplified by the pivot P6. The link L6 is an example of the sixth link connecting the sixth pivot exemplified by the pivot P6 to the fifth pivot exemplified by the pivot P5. The rotary actuator provided in the pivot P4 is an example of a rotary actuator that rotates the fourth pivot exemplified by the pivot P4.

As described above, the joint structure 20 includes an actuator that varies a distance between the pivot P4 and the pivot P5 or generates a force, and a rotary actuator that drives the pivot P1 in a closed loop composed of a part of the link L1 and the links L2, L3, L6, and L5. In this configuration example, as in the first configuration example, since one closed loop is driven by two actuators, the pivot P1 and the pivot PE are affected by each other's posture and torque, and thus it is possible to provide an effect similar to that of the first configuration example. In addition, compared to the first configuration example, the joint structure 20 according to the second configuration example has an advantage that the center of gravity is located closer to the member R, which is an example of the body part.

Note that, in this closed loop, although an example in which the drive joint is the pivot P4 has been described, the drive joint may be one of the pivots P6 and P5. However, a case in which the pivot P4 or the pivot P6 is used as the drive joint is more advantageous in terms of mass distribution than in the case in which the pivot P5 is used as the drive joint.

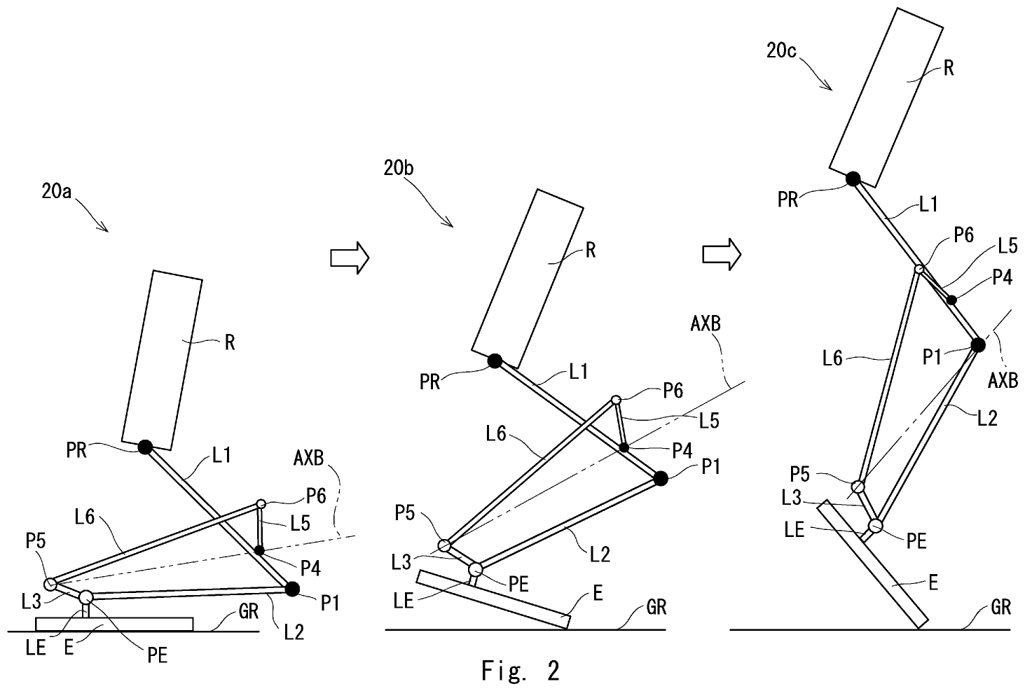

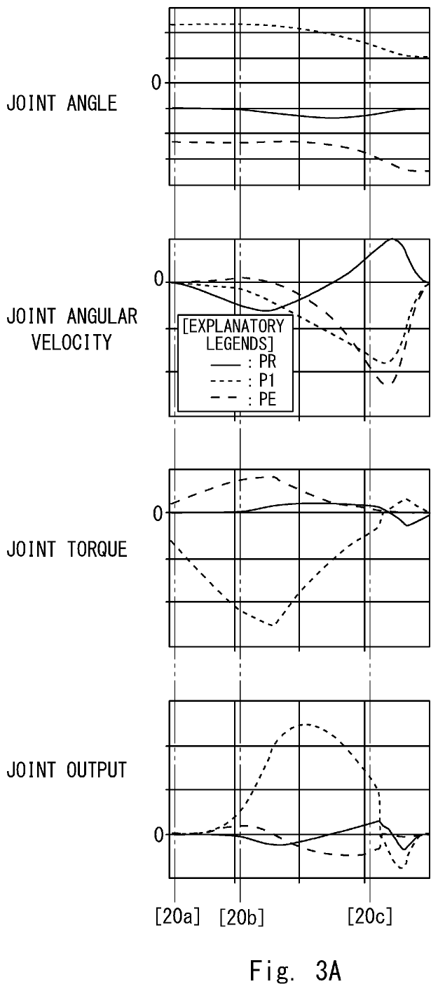

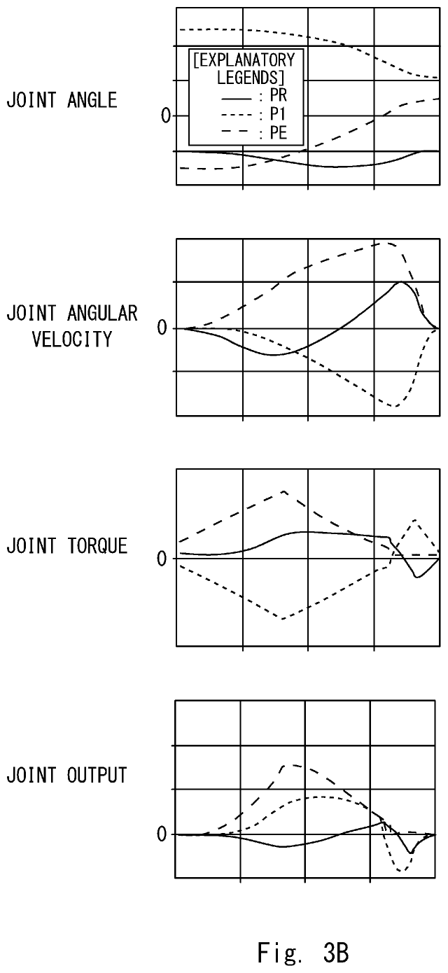

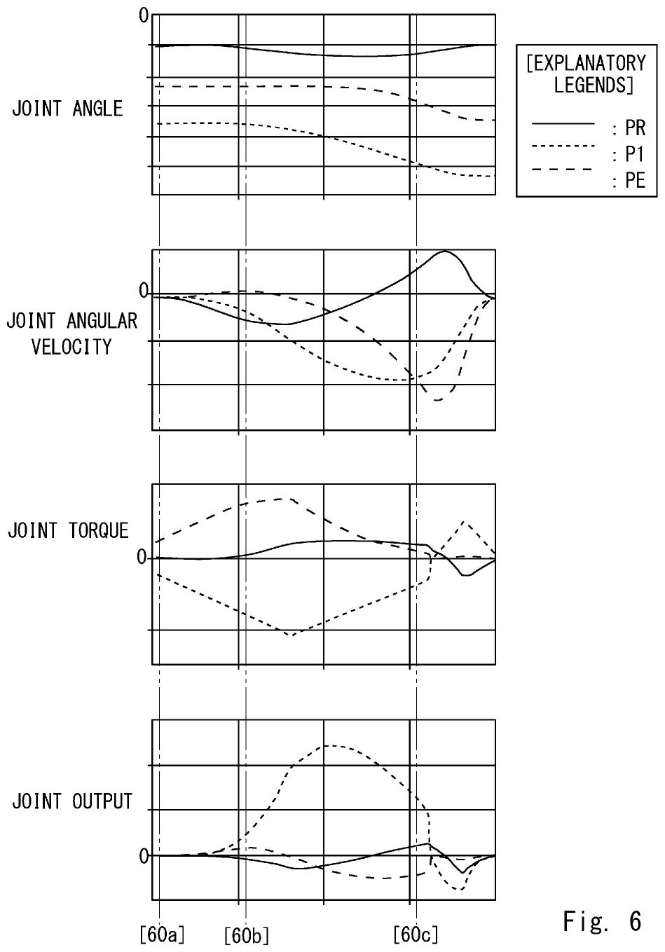

Next, an example of a state of each joint at each timing when jumping is performed as an action that requires high power will be described with reference to FIGS. 2, 3A, and 3B. FIG. 2 is a schematic diagram showing a change in a posture during jumping action in the second configuration example. FIG. 3A shows graphs showing results of calculating the displacements of respective joint parameters in accordance with the change in the posture shown in FIG. 2. FIG. 3B shows graphs showing results of calculating the displacement similarly for a comparative example in FIG. 1C. The horizontal axis of each graph in FIGS. 3A and 3B indicates time. In FIGS. 3A and 3B, and FIG. 6, which will be described later, the scale of the vertical axes of the respective joint parameters indicate the same range.

In FIG. 2, joint structures 20a, 20b, and 20c respectively show an initial-stage posture, a middle-stage posture and a late-stage posture at the time of a jumping action in the joint structure 20, and it can be seen that the quadrilaterals having the pivots P1, PE, P5, and P4 as vertices are deformed according to the respective postures. The joint structures 20a, 20b, and 20c show a squatting state, a jumping (leaping) and rising state, and a fully raised state, respectively.

FIG. 3A shows the displacements of joint parameters in accordance with the change in the posture during jumping action including the postures indicated by the joint structures 20a, 20b, and 20c. Four joint parameters of an angle, an angular velocity, torque, and an output are used as the joint parameters. Further, the graphs shown in FIG. 3A, the displacement of each joint parameter for the pivot P1 corresponding to the knee joint, the pivot PE corresponding to the ankle joint, and the pivot PR corresponding to the hip joint are indicated by dotted, dashed, and solid lines, respectively.

As shown in FIG. 3A, in the joint structure 20, it can be seen that the output of the pivot PE corresponding to the ankle joint is smaller than that of the pivot P1 corresponding to the knee joint from the initial-stage posture to the late-stage posture. In other words, in the joint structure 20, the size of the linear actuator provided in the link L4LA can be reduced since the output required for the pivot PE is high, which is advantageous in terms of total mass and mass distribution.

The joint structure 100 of a biped walking robot according to the comparative example is a serial link structure, and as shown in FIG. 1C, the link L1 and the link L2 are connected through the pivot P1 provided with an actuator. Further, in the joint structure 100, the link L1 and the member R are connected through the pivot PR provided with an actuator. In the joint structure 100, the link L2 and the link LE are connected through the pivot PE provided with an actuator, and the member E for grounding it to the ground GR is connected to the link LE.

FIG. 3B shows results of calculating the displacements of the respective joint parameters in accordance with a change in a posture during jumping action in the joint structure 100. In FIG. 3B, four joint parameters of an angle, an angular velocity, torque, and an output are used as the joint parameters, and the displacements of the joint parameters for the pivots P1, PE, and PR in the joint structure 100 are indicated by a solid line, a dotted line, and a dashed line, respectively.

As shown in FIG. 3B, in the joint structure 100, it can be seen that the output of the pivot PE corresponding to the ankle joint is larger than that of the pivot P1 corresponding to the knee joint from the initial-stage posture to the middle-stage posture. In other words, in the joint structure 100, it is necessary to increase the size of the actuator provided in the pivot PE since the output required for the pivot PE is high, which is disadvantageous in terms of total mass and mass distribution as compared to the case of the joint structure 20.

The magnitude of the output of the pivot PE corresponding to the ankle joint can be seen from the comparison between FIGS. 3A and 3B. Specifically, from this comparison, it can be seen that the output of the pivot PE corresponding to the ankle joint in the joint structure 20 is reduced as compared to that in the joint structure 100 in all the processes including the initial-stage posture, the middle-stage posture, and the late-stage posture. This shows that in the joint structure 20, as compared to the joint structure 100, the driving force in the pivot PE is secured by the rotary actuator that drives the pivot P1.

The mass distribution will now be described in a supplementary manner. For a robot having a leg structure, it is important to increase the power-to-weight ratio of the robot in order to demonstrate a high motion performance such as running and jumping. In particular, in the leg structure, it is desirable that not only the total mass be light, but also the mass distribution be light as it goes from the crotch part to the foot part of the leg. In the structure of the foot part, a system in which the ankle joint is directly driven by a rotary actuator or a system in which the shin part and the foot part are connected and driven by a linear actuator is common. However, the actuator having a large mass is located below the knee part, and thus the inertia seen from the crotch part is large and the load is increased. In other words, in such a common structure, since a large mass tends to be necessarily placed on the foot part side, the inertia seen from the crotch side is large and the load is increased, and therefore an actuator with a larger output is required. Further, a large output is required for the ankle joint in a situation where a high motion performance is required. Thus, as the motion performance of the robot to be required becomes higher, an actuator with a higher output, that is, a larger mass, is required. As described above, in a leg-type robot, how to arrange an actuator of the foot part is a problem, since the foot part is far from the hip joint although a high output is required for the foot part. In addition, unlike the common structure described above, an actuator of the foot part can be mounted near the hip joint by a parallel link mechanism or the like. However, as long as the ankle joint is driven by a single actuator, the required output itself does not change. Thus, the size of the actuator of the foot part does not change, and the structure of the link mechanism becomes complicated since it is located across the knee joint. As described above, a structure in which an actuator of the foot part can be arranged near the hip joint as much as possible and the output of the actuator can be reduced is required.

On the other hand, in the joint structure 20, it is possible to reduce the output of the actuator of the foot part by interference-driving the knee joint and the ankle joint through a link mechanism, whereby it is possible to make the structure suitable for the mass distribution of the foot part. The above effect on the joint structure 100, other general structures, and structures in which a link mechanism is located across the knee joint, in addition to the joint structure 20, can be obtained in other joint structures according to this embodiment described in the first configuration example and the third to the eighth configuration examples described later.

### THIRD TO FIFTH CONFIGURATION EXAMPLES

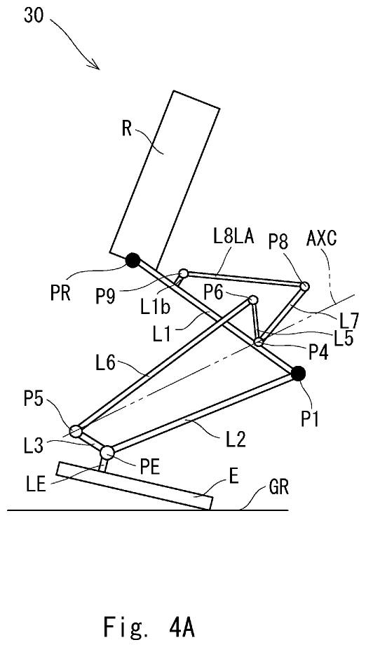

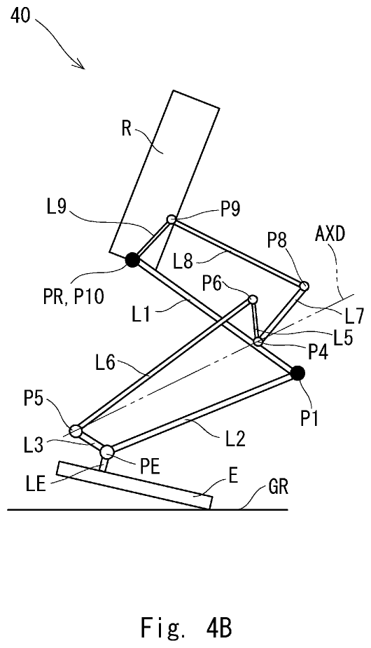

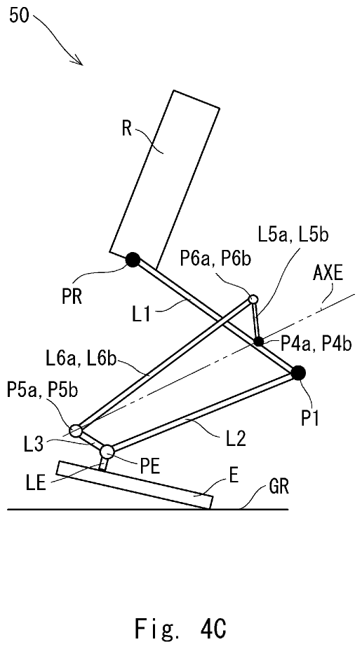

Joint structures of the third to the fifth configuration examples will be described with a fucus on differences between these structures and that according to the second configuration example with reference to FIGS. 4A, 4B, and 4C. However, various examples described in the first and the second configuration examples can be similarly applied.

A joint structure 30 according to the third configuration example shown in FIG. 4A has a structure in which the pivot P4 is rotated by a linear actuator in which one side thereof connected to the link L1 and the other side thereof connected to the link L5 in the joint structure 20. Note that the linear actuator is incorporated into a variable length link shown by a link L8LA, and one end and the other end of the link L8LA are connected to pivots P8 and P9, respectively. A link L7 is connected to the pivot P8, and the link L6 is connected to the link L7. Note that the link L7 and the link L6 are connected to the pivot P4 at a fixed angle. That is, the link L7 and the link L6 are formed as one link bent in the pivot P4. The joint structure 30 includes a link L1b extending from the link L1 in a state where the angle with respect to the link L1 is fixed, and the pivot P9 is connected to the link L1b.

As described above, the joint structure 30 includes, as the force application parts, the pivots P4, P5, P6, P8, P9, and P10, the links L5, L6, L7, L9, and Lb1, and the link L8LA, which is a variable length link in which a linear actuator is incorporated, and a force is applied on a line AXC. In the joint structure 30, as compared to the joint structure 20, an actuator that drives the ankle joint can be arranged close to the member R corresponding to the body part, so that the structure is more suitable for the mass distribution of the leg than the joint structure 20.

A joint structure 40 according to the fourth configuration example shown in FIG. 4B has a structure in which a rotary actuator that drives the pivot P4 is provided in a pivot P10, the pivot P10 is arranged coaxially with the pivot PR, and power is transmitted by a four-link structure in the joint structure 20. Note that the four-link structure comprises a part of the link L1 and the links L7, L8, and L9. The link L7 and the link L6 are formed as one link bent in the pivot P4. One end of the link L7 is connected to the pivot P4. The pivot P8 is connected to the other end of the link L7, and one end of the link L8 is connected to the pivot P8. The pivot P9 is connected to the other end of the link L8, and one end of the link L9 is connected to the pivot P9. The pivot P10 is connected to the other end of the link L9. Note that the pivot P10 need not necessarily be coaxial with the pivot PR.

As described above, in the joint structure 40, the pivots P4, P5, P6, P8, P9, and P10 and the links L5, L6, L7, L8, and L9 are provided as the force application parts, and a rotary actuator is provided in the pivot P10, and a force is applied on a line AXD. In the joint structure 40, as compared to the joint structures 20 and 30, an actuator that drives the ankle joint can be arranged close to the member R corresponding to the body part, so that the structure is more suitable for the mass distribution of the leg than the joint structures 20 and 30.

In a joint structure 50 according to the fifth configuration example shown in FIG. 4C, closed loops A and B described below are arranged three-dimensionally in the front side direction and the back side direction in FIG. 4C, respectively. The closed loop A is composed of the link L1, the pivot P1, the link L2, the pivot PE, the link L3, a pivot P5a, a link L6a, a pivot P6a, a link L5a, and a pivot P4a. The closed loop B is composed of the link L1, pivot P1, the link L2, pivot PE, the link L3, a pivot P5b, a link L6b, a pivot P6b, a link L5b, and a pivot P4b.

Each of the structures of the closed loops A and B is a structure described as the joint structure 20. However, the joint structure 50 has the closed loops A and B, and the pivot PE serves as a joint having two degrees of freedom, and the pivots P6a, P6b, P5a, and P5b serve as joints or spherical joints having two degrees of freedom, and a rotary actuator that drives the pivot P4a and a rotary actuator that drives the pivot P4b are provided. Further, the joint structure 50 includes the pivot P4a in which a rotary actuator is provided, the pivots P5a and P6a, and the links L5a and L6a as the force application parts, and a force is applied on a line AXE. Further, the joint structure 50 includes the pivot P4b in which a rotary actuator is provided, the pivots P5b and P6b, and the links L5b and L6b as the force application parts, and a force is applied on the line AXE.

When the closed loop A and the closed loop B move in the same phase, the pivot PE exemplified by the ankle joint can perform movement in a pitch direction. On the other hand, when the closed loop A and the closed loop B move in the opposite phase, the pivot PE exemplified by the ankle joint can perform movement in a roll direction. Further, in the joint structure 50, in addition to the effect of the joint structure 20, the pitch of the pivot PE exemplified by the ankle joint and movement of the roll can be freely performed, and the torque of the rotary actuator of the pivot P1 exemplified by the knee joint can be utilized for each movement.

Further, although an example in which the pivot P4a and P4b are arranged coaxially in the joint structure 50, they need not be arranged coaxially, in which case the line AXE in the closed loop A and the line AXE in the closed loop B are different from each other. Further, in the closed loop A, a rotary actuator that drives the pivot P6a or P5a may be provided instead of the rotary actuator that drives the pivot P4a. Similarly, in the closed loop B, a rotary actuator that drives the pivot P6b or P5b may be provided instead of the rotary actuator that drives the pivot P4b.

Further, a modification of the joint structure 50 with respect to the joint structure 20 can also be applied to the third configuration example and the fourth configuration example, that is, a configuration in which two closed loops are provided can be adopted in the joint structure 30 and a configuration in which two closed loops are provided can be adopted in the joint structure 40.

### SIXTH TO EIGHTH CONFIGURATION EXAMPLES

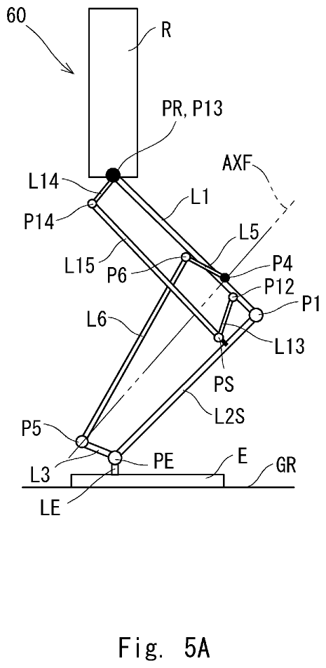

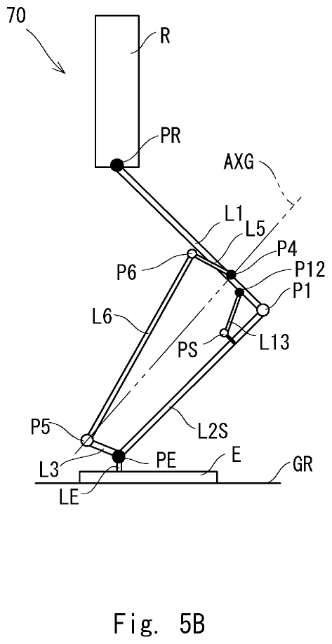

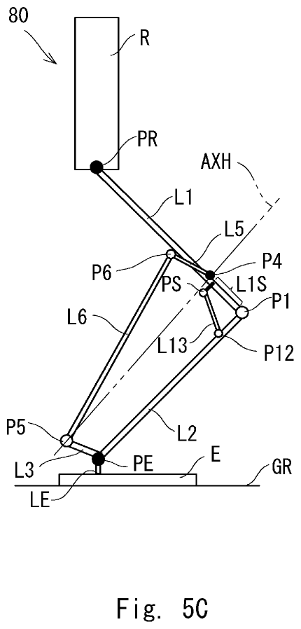

Joint structures of the sixth to the eighth configuration examples will be described with a fucus on differences between these structures and that according to the second configuration example with reference to FIGS. 5A, 5B, 5C, and 6. However, various examples described in the first to the fifth configuration examples can be similarly applied.

In a joint structure having an interference driving mechanism, such as joint structures according to the first to the fifth configuration examples, the interference driving mechanism reduces the output of the foot part, but increases the output of the pivot P1 exemplified by the knee part. In particular, since the joint torque at the pivot P1 increases greatly, a size of the actuator increases due to the torque increase of a motor or the like, the strength increase of a speed reducer, etc. Therefore, in the joint structure according to the sixth to the eighth configuration examples, in the joint structure having an interference driving mechanism, the increase in the output at the pivot P1 is reduced and the torque at the pivot P1 is also reduced by adding a transmission mechanism that enables the rotation speed of the pivot P1 to be changed. Thus, the size and the weight of the actuator can be reduced, whereby the motion performance can be improved and the inertia of the whole leg can be reduced. Although the sixth to the eighth configuration examples will be described below, a transmission mechanism of another mechanism may be used as the transmission mechanism.

A joint structure 60 according to the sixth configuration example shown in FIG. 5A has a structure in which the link L2 is a slide link L2S, and links L13, L14, and L15, a slide pivot PS, pivots P12, P13, and P14, and a rotary actuator that rotates the pivot P13 in the joint structure 20. Note that the line of the force application part is indicated by a line AXF.

The link L13 is an example of a seventh link in which one end thereof is connected to the first link exemplified by the link L1 at a position closer to the pivot P1 and the other end thereof is connected to a slide part exemplified by the slide pivot PS. The slide pivot PS is an example of the slide part connected to the second link exemplified by the slide link L2S so as to be slidable, and may include a pivot rotatably connected to the links L13 and L15 and a link-like member extending from the pivot. The link-like member may be installed on the slide link L2S so as to be slidable. The link L14 is a link connecting the pivot P13 to the pivot P14, and the link L15 is a link connecting the pivot P14 to the slide pivot PS. The pivot P12 rotatably connects the link L13 to the link L1, the pivot P13 rotatably connects the link L14 to the member R, and the pivot P14 rotatably connects the link L14 to the link L15.

The pivot P13 is a pivot coaxial with the pivot PR, but it can also be a pivot non-coaxial with the pivot PR. Note that the pivot P13 is a pivot provided in the member R which is an example of a member other than the link L1, but it may be a pivot provided in the link L1 at a position closer to the member R than the pivot P2 is. That is, a rotary actuator of the pivot P13 in the joint structure 30 may be an actuator which rotates the link L14 relative to the link L1 by rotating the pivot P13. Therefore, the rotary actuator provided in the pivot P13 may be fixed to the member R to drive the link L14 relative to the link L1, or fixed to the link L1 to drive the link L14 relative to the link L1.

That is, when the link L1 is considered as a stationary joint, the joint structure 60 may include a four-link structure in which the link L14 is a driving joint, the link L15 is an intermediate joint, and the link L13 is a driven joint. As a matter of course, this four-link structure does not need to be a parallel link structure. For example, when the link L14 is shorter than the link L13, the deceleration ratio can be set to be higher, and in the reverse case, the deceleration ratio can be set to be lower.

As described above, the joint structure 60 has a variable-speed structure of the knee joint that connects the link L1 to the slide link L2S in a simple structure, and can be set so as to increase the deceleration ratio so that the torque of the actuator increases in a posture in which a knee joint load is high, and so that the deceleration ratio decreases as it becomes close to an upright posture and it can operate at a high speed. In other words, in the joint structure 60, a deceleration effect can be obtained in a high-load posture when driving a joint. Note that the posture in which a load is high can refer to a squatting posture. The deceleration ratio herein refers to the ratio of the speed of the pivot P1 functioning as an output joint to an input speed of the actuator.

In order to explain how the torque at the pivot P1 is reduced, an example of a state of each joint at each timing when jumping is performed as an action that requires high power will be described with reference to FIG. 6. FIG. 6 shows graphs showing results of calculating the displacements of the respective joint parameters which are the same as those in FIG. 3A in accordance with a change in a posture during jumping action in the joint structure 60. In FIG. 6, the horizontal axis in each graph indicates time, and timings corresponding to the initial, the middle, and the late postures in FIG. 3A are indicated by symbols 60a, 60b, and 60c, respectively.

As shown in FIG. 6, in the joint structure 60, it can be seen that the peak torque of the pivot P1 is smaller than that in the graph in FIG. 3A. The reason why the peak torque can be reduced in this way is that the joint structure 60 has a structure that changes a variable-speed ratio in accordance with the posture, that is, has a variable-speed effect for the applied torque in accordance with the posture, as described above.

A joint structure 70 according to the seventh configuration example shown in FIG. 5B, in the joint structure 60, includes a rotary actuator that rotates the pivot P12 instead of the four-link structure. Note that the line of the force application part is indicated by a line AXG.

A joint structure 80 according to the eighth configuration example shown in FIG. 5C has a vertically reversed configuration of the configuration which comprises the links L1 and L13, the slide link L2S, the pivot P12, and the slide pivot PS in the joint structure 70, and includes a linear actuator. Therefore, in the joint structure 80, a part of the link L1 on the pivot P1 side shown as a link L1S is a slide link including a linear actuator instead of a rotary actuator that rotates the pivot P12 in the joint structure 70. Note that the line of the force application part is indicated by a line AXH. The joint structure 80 is more advantageous in terms of the mass distribution of the leg than the joint structure 70.

Further, the joint structures according to the sixth to the eighth configuration examples are not required to adopt a double-angle structure using gears or the like in a largely movable joint such as a knee. Since it is practically difficult to achieve zero backlash in a structure in which interlocking is performed by gears, there are restrictions such as that a control gain cannot be increased due to rattling of the joint. However, in the joint structures according to the sixth to the eighth configuration examples, there are no restrictions described above. Further, in the case of a high-power robot, relatively large steel gears may be required for strength reasons, which may increase the weight thereof. However, in the joint structures according to the sixth to the eighth configuration examples, the above large steel gears are not required.

Note that the present disclosure is not limited to the above-described embodiment and may be changed as appropriate without departing from the scope of the present disclosure. For example, regarding various types of joint structures according to the above embodiment, an example of a case in which the pivot P1 of the knee joint is one revolute joint has been described. However, the present disclosure is not limited thereto. For example, various structures such as a multi-joint link mechanism and a double joint in which the links connected to the pivot P1 can be flexed and extended relative to each other may be employed.

Further, for example, although various types of joint structures according to the above embodiment have been described in accordance with the assumption that the robot is a robot capable of walking on two legs, the present disclosure is not limited thereto and various types of robots can be applied, such as a robot that moves while jumping on one leg, a robot that walks on three or more legs, e.g., four legs, and a robot that has one or more arms. Further, the description has been given in accordance with the assumption that the joint structure is applied to a knee and an ankle as two joints. However, it can also be applied to other two joints. For example, when a robot has an arm with or without a leg, the above joint structure can be applied to an elbow and a wrist, which is also referred to as a hand joint, in a robot that performs an action such as throwing an object with a hand part thereof. Further, the robot may be an autonomous mobile robot, a robot remotely controlled by a user, a robot piloted by a user riding thereon, or a robot having more than one of these functions. Further, there is no particular limitation on the appearance of the robot.

Note that the robot may include a sensor group for detecting the robot's posture etc., and a control unit that controls the driving of one or a plurality of actuators included such as the above-described actuator. Note that the sensor group may be composed of a plurality of sensors that detect positions, angles, and the like of the robot at various places and transfer them to the control unit, and a group of sensors of any type by which the robot's posture can be detected directly or computationally may be used. The control unit may be a part that controls actions of the robot including a driving control of the actuator, and may be a part that controls the whole robot. The control unit may be implemented by, for example, an Integrated Circuit. For example, it may be implemented by a processor such as a Micro Processor Unit (MPU) or Central Processing Unit (CPU), a work memory, a nonvolatile storage device, and the like. A program for control executed by the processor is stored in the storage device, and the processor loads the stored program into the work memory and executes it, thereby performing the function of the robot.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A joint structure of a robot, comprising:
a first link, one end of the first link being connected to a first member;
a second link;
a first pivot connected to an other end of the first link and connected to one end of the second link;
a second pivot connected to an other end of the second link and connected to one end of a second member;
an actuator configured to rotate the first pivot;
a third link, one end of the third link being connected to the second pivot and the third link facing in a direction away from the second link; and
a force application part configured to apply a force on a line connecting a predetermined position on the first link to an other end of the third link.

2. The joint structure according to claim 1, wherein the force application part comprises: a fourth pivot connected to the predetermined position on the first link; a fifth pivot connected to the other end of the third link; a fourth link configured to connect the fourth pivot to the fifth pivot; and an actuator configured to change a length of the fourth link.

3. The joint structure according to claim 1, wherein the force application part comprises: a fourth pivot connected to the predetermined position on the first link; a fifth pivot connected to the other end of the third link; a sixth pivot; a fifth link configured to connect the fourth pivot to the sixth pivot; a sixth link configured to connect the sixth pivot to the fifth pivot; and a rotary actuator configured to rotate the fourth pivot.

4. The joint structure according to claim 1, comprising a changing mechanism configured to change the predetermined position.

5. The joint structure according to claim 1, comprising: a seventh link, one end of the seventh link being connected to the first link at a position closer to the first pivot than the predetermined position on the first link is; and a slide part connected to the second link so as to be slidable,
wherein an other end of the seventh link is connected to the slide part.
